(19) United States
(12) Patent Application Publication
(10) Pub. No.: US 2017/0343648 A1
(43) Pub. Date: Nov. 30, 2017

(54) Radar Systems and Methods for Operating a Radar System

(71) Applicant: Infineon Technologies AG, Neubiberg (DE)

(72) Inventors: Saverio Trotta, Muenchen (DE); Reinhard Wolfgang Jungmaier, Aying (DE); Dennis Noppeney, Köln (DE)

(21) Appl. No.: 15/608,649

(22) Filed: May 30, 2017

(30) Foreign Application Priority Data
May 30, 2016 (DE) 102016109910.4

(51) Int. Cl. G01S 7/35; G01S 13/42; G01S 13/34

(52) U.S. Cl. CPC G01S 7/35; G01S 13/34; G01S 13/42

(57) ABSTRACT

A method for operating a radar system includes increasing a frequency of a radar signal during a first time interval and transmitting the radar signal from a first transmit antenna during the first time interval. Moreover, the method includes decreasing the frequency of the radar signal during a second time interval and transmitting the radar signal from a second transmit antenna during the second time interval.

This application claims priority to German patent application No. 102016109910.4, filed on May 30, 2016, which application is hereby incorporated herein by reference in its entirety.

### TECHNICAL FIELD

Embodiments relate to concepts for modulating radar signals and in particular to radar systems and methods for operating radar systems.

### BACKGROUND

Modulation of radar signals is desired for a large variety of applications. For example, providing a frequency modulated radar signal of high bandwidth, high frequency accuracy, very short chirp times, and low phase noise is a difficult task. Often, these different properties have to be traded off against each other. Portable, battery-powered applications may benefit from low power radar concepts.

There may be a demand to provide an improved concept for operating radar systems, which can provide a higher accuracy for determining the position and/or speed of a target and reduce power consumption of the radar system.

### SUMMARY

Some embodiments relate to a method for operating a radar system. The method comprises increasing a frequency of a radar signal during a first time interval and transmitting the radar signal from a first transmit antenna during the first time interval. Moreover, the method comprises decreasing the frequency of the radar signal during a second time interval and transmitting the radar signal from a second transmit antenna during the second time interval.

Some embodiments relate to a radar system. The radar system comprises a first transmit antenna and at least one second transmit antenna. Further, the radar system comprises a phase-locked loop. The phase-locked loop is configured to increase the frequency of a radar signal during a first time interval. Additionally, the phase-locked loop is configured to decrease the frequency of the radar signal during a second time interval. Moreover, the radar system comprises a signal switch. The signal switch is configured to switch the radar signal to the first transmit antenna during the first time interval and to switch the radar signal to the second transmit antenna during the second time interval.

### BRIEF DESCRIPTION OF THE DRAWINGS

Some embodiments of apparatuses and/or methods will be described in the following by way of example only, and with reference to the accompanying figures, in which

FIG. 1 shows a flow chart of a method for operating a radar system;

FIG. 2 shows an example of a frequency modulation of a radar signal;

FIG. 3 shows an example of a frequency domain representation of received reflections of a radar signal;

FIG. 4 displays a table comprising Doppler frequency shifts and frequency shifts due to a distance to the target for various distances and various speeds of the target;

FIG. 5a shows a division of a range of a radar system into range gates;

FIG. 5b shows how an intermediate frequency at a receiver side of a radar system can be related to a distance to a target;

FIG. 6 shows a block diagram of a radar system;

FIG. 7a shows another block diagram of a radar system;

FIG. 7b illustrates a concept, how a plurality of transmit elements can form a plurality of synthetic receiving channels for a radar system;

FIG. 8a shows another example of a frequency modulation of a radar signal;

FIG. 8b shows an example of a frequency tuning curve of a voltage-controlled oscillator; and

FIG. 8c shows an example of a tuning sensitivity curve of a voltage-controlled oscillator.

### DETAILED DESCRIPTION OF ILLUSTRATIVE EMBODIMENTS

Various example embodiments will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like or similar elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

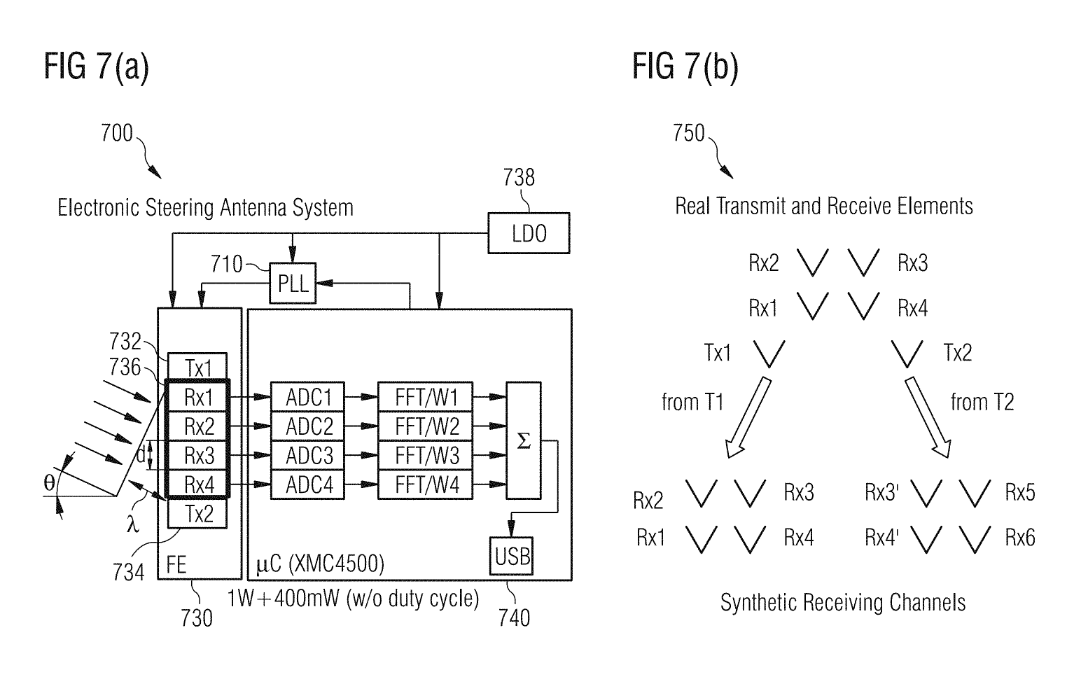

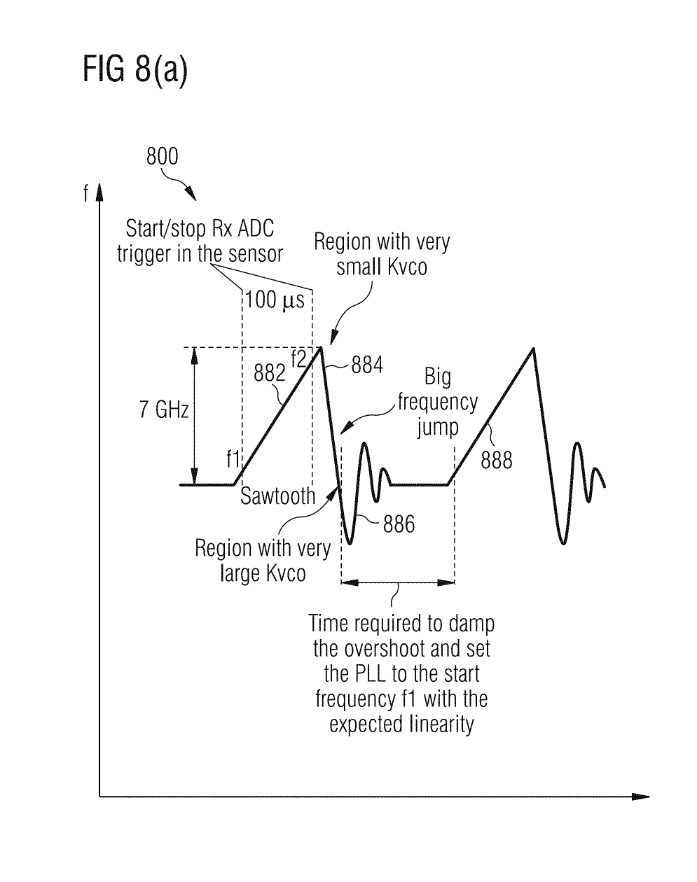

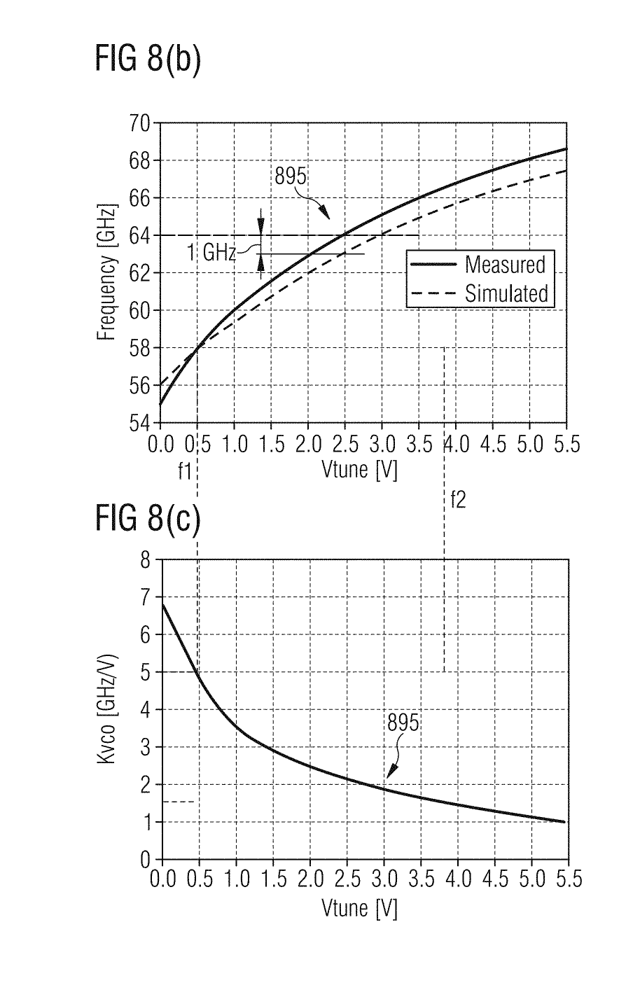

Modulation of radar signals is an established technique, for example, in pulse-compression radar systems. An example of a frequency modulation 800 of a radar signal is shown in FIG. 8a. The shown frequency modulation 800 performs saw tooth chirps 882, e.g., the frequency of the radar signal is linearly increased from a first radio frequency f₁ to a second radio frequency f₂ during a time interval of, for example, 100 μs. After reaching the second radio frequency f₂, the frequency of the radar signal is reset to the first radio frequency f₁ within a short time, for example within less than 5 μs, in order to perform the next saw tooth chirp 888.

Often radar systems, e.g., millimeter wave gesture sensing systems, require high resolution. High resolution can be achieved by using large radar bandwidths, e.g., the frequency difference between the first radio frequency f₁ and the second radio frequency f₂ is large, for example 7 GHz or larger. Hence, the reset of the frequency can cause a large frequency jump 884 corresponding to the radar bandwidth. The frequency jump 884 to the first radio frequency f₁ can then cause overshoots and oscillations 886 of the frequency of the radar signal, such that a settling time may have to pass before the frequency of the radar signal is stable again at the first radio frequency f₁. A long settling time, for example 50 μs or longer, can increase the overall duty cycle of the radar system and thus the overall power consumption.

If a phase-locked loop (PLL) is used to control the frequency of the radar signal, the PLL may need a large loop bandwidth in order to perform the frequency jump 884. A large loop bandwidth (for example, 1 MHz or larger) can however degrade the phase noise of the radar signal. An alternative dual loop PLL can introduce additional phase noise due to a second loop.

If the PLL comprises a voltage-controlled oscillator (VCO), the overshoots and oscillations 886 of the frequency of the radar signal may be aggravated as VCOs often have a higher tuning sensitivity K_{vco} at their lower frequency tuning range, e.g., at the first radio frequency as shown by the VCO tuning characteristic 890 in FIG. 8b and the corresponding VCO tuning sensitivity 895 in FIG. 8c. The tuning sensitivity K_{vco} can, for example, be larger than 5 GHz/V. Moreover, in portable applications, the tuning voltage range can be limited by a battery voltage of the radar system. In turn, a VCO with an even higher tuning sensitivity K_{vco} may be needed, which again may worsen the overshoots and oscillations 886 of the frequency of the radar signal.

Without limitation, embodiments of the present disclosure address these technical issues and provide solutions.

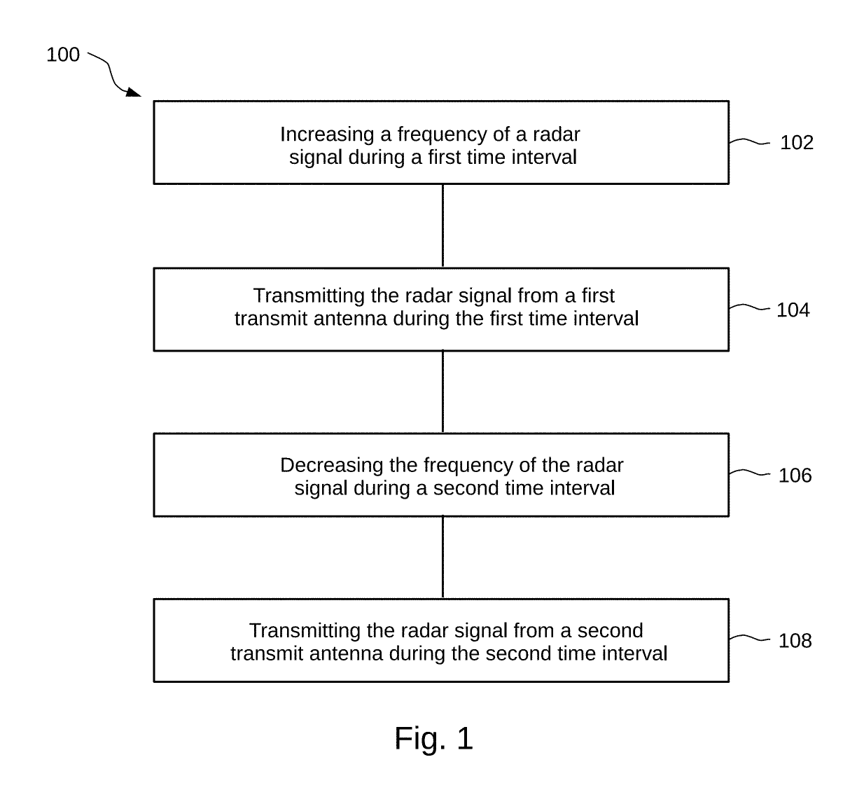

FIG. 1 shows a flow chart of a method 100 for operating a radar system according to an embodiment of the present disclosure. The method 100 comprises increasing 102 a frequency of a radar signal during a first time interval and transmitting 104 the radar signal from a first transmit antenna during the first time interval. Moreover, the method comprises decreasing the frequency 106 of the radar signal during a second time interval and transmitting 108 the radar signal from a second transmit antenna during the second time interval.

By transmitting a radar signal from a first transmit antenna during a first time interval, while increasing the frequency of the radar signal, and by transmitting the radar signal from a second transmit antenna during a second time interval, while decreasing the frequency of the radar signal, an intermediate time period between the transmission during the first and the second time interval can be shortened. In other words, after having transmitted the radar signal from the first antenna, it can be provided within a shorter time at the second antenna. In this way, a radar system can illuminate a target with electromagnetic energy more continuously, e.g., with shorter and/or less interruptions. In turn, this can result in a more reliable, faster, and more accurate detection and/or tracking of a target. Additionally, the transmissions of the radar signal from the first and the second transmit antenna can be performed within a shorter time, which can reduce an overall duty cycle of the radar system and can hence decrease the power consumption of the radar system. That is to say, by transmitting the radar signal from the first and second transmit antenna while increasing and decreasing its frequency, respectively, a reset of the frequency of the radar signal to a start frequency and hence a time to perform this reset can be circumvented. Avoiding such a reset (e.g., avoiding a saw tooth function of the frequency modulation of the radar signal with large frequency discontinuities and/or large frequency jumps), also avoids that the frequency of the radar signal can overshoot and/or oscillate and a corresponding settling time may have to pass, before the radar signal can be provided at the second (or first) transmit antenna again.

The radar signal can be an analog signal or a digital signal. The analog or digital radar signal can comprise a continuous-wave signal or a pulsed signal. In case of a digital radar signal, before transmitting the radar signal, it can be converted from a digital domain to an analog domain by a digital-to-analog converter. Further, the radar signal can be a carrier frequency signal, an intermediate frequency signal, or a baseband signal. In case of a baseband signal or an intermediate frequency signal, the radar signal can be up-converted to a carrier frequency domain before transmitting. This can, for example, comprise the usage of a mixer and/or a frequency multiplier. Optionally, the radar signal can be amplified and/or filtered before being transmitted.

The radar signal can, for instance, be provided by an oscillator. The oscillator can for example comprise a variable-frequency oscillator. This variable-frequency oscillator can, for example, comprise a voltage-controlled oscillator and/or a numerically controlled oscillator (NCO). The oscillator can be comprised by a phase-locked loop (PLL), for example, an analog PLL, a digital PLL, or a hybrid PLL comprising analog and digital signals and circuitry.

Increasing the frequency of the radar signal during the first time interval and decreasing the frequency of the radar signal during the second time interval can comprise a frequency modulation of the radar signal. The frequency modulation can, for example, comprise linear frequency modulation. In linear frequency modulation, the frequency of the radar signal can be linearly increased over the first time interval, herein and hereinafter referred to as a linear frequency up-chirp (or short just as up-chirp), and can be linearly decreased over the second time interval, herein and hereinafter also referred to as a linear frequency down-chirp (or short just as down-chirp).

Controlling the frequency of the radar signal, e.g., increasing and/or to decreasing the frequency of the radar signal, can comprise controlling the oscillator that provides the radar signal. For example, in case of a voltage-controlled oscillator (VCO) comprised by a PLL, controlling the frequency of the VCO (e.g., the frequency of the radar signal) can comprise dividing the frequency of the radar signal by a divider, comparing the divided frequency and/or phase of the radar signal to a frequency and/or phase of a reference signal, and adjusting a tuning voltage of the VCO correspondingly. For example, increasing the divider can result in a higher tuning voltage, which in turn can result in an increased frequency of the radar signal. Analogously, decreasing the divider can lead to a lower tuning voltage and hence to a decreased frequency of the radar signal, for example.

According to the method 100, increasing the frequency of the radar signal can, for example, comprise increasing the frequency from a first radio frequency to a second radio frequency. Furthermore, decreasing the frequency of the radar signal can comprise decreasing the frequency from the second radio frequency to the first radio frequency. In this way, the same frequency range (e.g., the same frequency band and a same radar bandwidth) can be used, for instance, for the linear frequency up-chirp and the linear frequency down-chirp. This can, for example, reduce the hardware complexity of a radar system operating according to the method 100 and hence reduce the power consumption of the radar system.

Additionally, the method 100 can optionally comprise maintaining the frequency of the radar signal during an intermediate time period. Herein, the intermediate time period can directly succeed (e.g., follow) the first time interval and can directly precede (e.g., take place before) the second time interval. That is to say, the frequency of the radar signal can be kept constant during the intermediate time interval, wherein the first time interval, the intermediate time period, and the second time interval can take place directly one after the other. By maintaining the frequency of the radar signal during the intermediate time period, a radar system operating according to an embodiment of the method 100 can reduce its power consumption as it can, for example, avoid a reset of the frequency of the radar signal as described above. Avoiding a reset of the frequency of the radar signal, can shorten the overall duty cycle and reduce the numbers of operations of the radar system.

Furthermore, maintaining the frequency of the radar signal during the intermediate time period can optionally comprise maintaining the frequency at the second radio frequency. In this way, the frequency of the radar signal can be increased from the first radio frequency to the second radio frequency during the first time interval, while the radar signal can be transmitted from the first transmit antenna. Directly afterwards, during the intermediate time period, the frequency of the radar signal can be maintained at the second frequency. The frequency of the radar signal is not changed, but can be kept constant at the second radio frequency to which the frequency of the radar signal has already been tuned to. Directly following the intermediate time period, the frequency of the radar signal can be decreased from the second radio frequency to the first radio frequency during the second time interval, while the radar signal can be transmitted from the second transmit antenna.

In this way, the last frequency (e.g., a stop frequency) to which the frequency of the radar signal is tuned to during the first time interval can correspond (e.g., be identical) to the first frequency (e.g., a start frequency) of the radar signal during the second time interval. Hence, at the end of the first time interval, the frequency of the radar signal for transmission during the second time interval is already tuned to the start frequency of the second time interval. In turn, a time for tuning the frequency of the radar signal for starting the transmission during the second time interval can be spared. Consequently, the PLL comprising, for example, a VCO may only need to follow (e.g., control) continuous (e.g., small) frequency changes, for example, frequency changes less than 1.0%, less than 0.5%, or less than 0.2% relative to the carrier frequency of the radar signal. In turn, the PLL may comprise a smaller loop bandwidth. A smaller loop bandwidth (for example, a loop bandwidth reduced by a factor larger than three, larger than five, or even larger than ten) can result in reduced phase noise of the radar signal and in higher linearity of the frequency up-chirps and down-chirps. The loop bandwidth may, for example, be smaller than 500 kHz, e.g., between 300 kHz and 500 kHz, between 100 kHz and 300 kHz, or even less than 100 kHz. Moreover, a continuity of the frequency of the radar signal can avoid and/or reduce overshoots of the frequency of the radar signal. Reduced phase noise, avoided and/or reduced frequency overshoots, and improved linearity of the frequency up-chirps and down-chirps can then lead to a higher accuracy of a radar system operating according to the method 100 in terms of positioning and tracking of a target.

Optionally, the method 100 can, in addition, comprise switching the radar signal from the first transmit antenna to the second transmit antenna during the intermediate time period. Switching the radar signal can, for example, comprise operating a signal switch, such as a transistor-switch, a diode-switch, and/or a relay. By switching the radar signal from the first transmit antenna to the second transmit antenna, a common PLL and hence a common oscillator (e.g., a common VCO) can be employed for the transmission of the radar signal from the first transmit antenna and from the second transmit antenna. This can, in turn, decrease the hardware complexity and hence the power consumption of a radar system operating according to an embodiment of the present disclosure. Switching the radar signal can further comprise switching the radar signal from the second transmit antenna back to the first transmit antenna.

According to the method 100, the first time interval can optionally be longer than half the second time interval and shorter than double the second time interval. In other words, the length of the first time interval and the length of the second time interval can be within the same order of magnitude. If, in addition and optionally, the frequency of the radar signal is increased from a first radio frequency to a second radio frequency during the first time interval, and is decreased from the second radio frequency to the first radio frequency during the second time interval, a first rate by which the frequency of the radar signal is increased during the first time interval can be between half and double of a second rate by which the frequency of the radar signal is decreased during the second time interval. In this way, a common PLL with a common loop bandwidth can be used for increasing the frequency of the radar signal during the first time interval and for decreasing the frequency of the radar signal during the second time interval, such that phase noise and linearity of the frequency up-chirps and down-chirps can be equally (or similarly) good during transmissions of the first and second time interval. Moreover, the first and the second time interval may have the same length, for example.

Furthermore, the first time interval and/or the second time interval can, for example, be at least thirty times longer than the intermediate time period. In some examples, the first time interval and/or the second time interval can be more than fifty times, more than a hundred times, or even more than two hundred times longer than the intermediate time period. In other words, the intermediate time period can be relatively short compared to the first and/or the second time interval. If, for example, the transmission is halted (e.g., interrupted) during the intermediate time period, for example, to switch the radar signal from the first to the second transmit antenna, keeping the duration of the intermediate time period relatively short can allow an on average longer illumination of a target with electromagnetic energy and can hence lead to a more accurate position determination and/or a more accurate tracking of the target. For example, both the first and the second time period can be 100 μs long, whereas the intermediate time period can be between 1 μs and 2 μs long, or even shorter than 1 μs.

Optionally, the method boo can further comprise receiving a first reflection of the radar signal from a target during the first time interval, receiving a second reflection of the radar signal from the target during the second time interval, and determining a position of the target based on the received first reflection of the radar signal and/or based on the received second reflection of the radar signal.

Optionally, the method boo can further comprise setting a modulation parameter of the radar signal to cause a Doppler frequency shift in the received reflections (e.g., the received first and second reflection) to be smaller than fifty times a frequency shift in the received reflections due to a distance to the target. In some examples, the Doppler frequency shift can be smaller than a hundred times, smaller than five-hundred times, or even smaller than a thousand times as the frequency shift due to the distance to the target by setting modulation parameters of the radar signal accordingly. In this way, the received first reflection and the received second reflection can be considered equivalent for determining the position of the target. Moreover, by reducing the Doppler frequency shift in the received reflections an intermediate frequency (IF) bandwidth on a receiver side of a radar system operating according to the method 100 can be reduced. A smaller IF bandwidth on the receiver side can in turn reduce the reception of spurious signals that would otherwise interfere with the received reflections and can also reduce thermal noise on the receiver side.

The set modulation parameter of the radar signal can, for example, comprise a carrier frequency (e.g., a radio frequency (RF) center frequency), the first radio frequency, the second radio frequency, a difference between the first radio frequency and the second radio frequency (e.g., a radar bandwidth), the length of the first time interval (e.g., an up-chirp time), and the length of the second time interval (e.g., a down-chirp time). These modulation parameters can have a direct influence on the Doppler frequency shift of the received reflections and on the frequency shift of the received reflections due to the distance to the target.

Optionally, according to the method 100, receiving the first reflection of the radar signal and receiving the second reflection of the radar signal can comprise digital beam-forming. A radar system operating according to the method 100 can, for example, comprise a receive antenna array, wherein each antenna element of the receive antenna array may be coupled to a dedicated receiver channel. By digital beamforming on the receiver side, a direction to the target from the radar system can be determined. For example, an angle of incidence of the first and/or the second reflection on the receive antenna array can be determined. This angle of incidence can correspond to the direction to the target from the radar system. By determining a distance to the target based on a frequency shift in the received reflections and by determining the direction to the target, the position of the target can be determined, for example.

According to the method 100, determining the position of the target can optionally comprise determining a first position of the target based on at least the first received reflection of the radar signal, determining a second position of the target based on at least the second received reflection of the radar signal, and determining an averaged position of the target based on at least the first position and on the second position. In this way, noise, e.g., amplitude and phase noise of the received reflections, can be significantly reduced (e.g., averaged). Hence, the position of the target may be determined with higher accuracy.

In some examples according to method 100, the target may be a living being or a body part of a living being. The living being may, for example, be a human being and/or an animal. In this way, a priori information about the target (e.g. a maximum speed of the target) can be known, such that a radar system operating according to method 100 can be designed for the detection of said targets. For example, if the radar system is used for determining the position of living beings and/or body pails of living beings, modulation parameters of the radar signal can be set to cause a Doppler frequency shift in the received reflections to be significantly smaller than a frequency shift in the received reflections due to a distance to the target, as explained above.

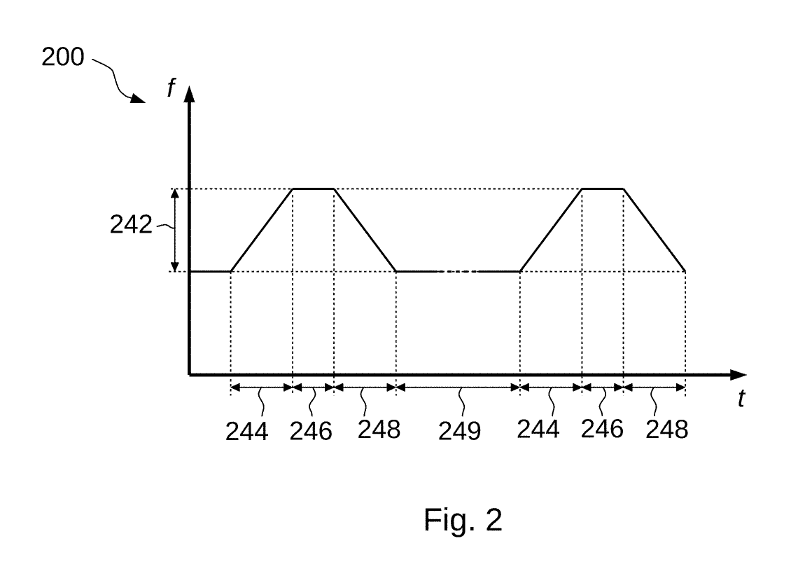

FIG. 2 shows an example of a frequency modulation 200 of a radar signal according to an embodiment of the present disclosure. During a first time interval 244 the frequency of the radar signal is linearly increased from a first radio frequency over a radar bandwidth 242 to a second radio frequency. The radar bandwidth (e.g., the difference between the first radio frequency and the second radio frequency) can for example be larger than 4 GHz, e.g., between 4 GHz and 6 GHz, between 6 GHz and 8 GHz, between 8 GHz and 10 GHz, or even larger than 10 GHz. Alternatively, the radar bandwidth 242 can be larger than 8% relative to the arithmetic mean value of the first and second radio frequency, e.g., between 8% and 10%, between 10% and 12%, between 12% and 15%, or even larger than 15%. The first and the second radio frequency can be higher than 40 GHz, e.g., between 40 GHz and 60 GHz, between 50 GHz and 75 GHz, between 60 GHz and 90 GHz, between 75 GHz and 110 GHz, or even higher than 110 GHz.

According to the example of FIG. 2, in the first instance of time of the first time interval 244 the frequency of the radar signal is equal to the first radio frequency, whereas in the last instance of time of the first time interval 244 the frequency of the radar signal is equal to the second radio frequency. The radar signal is transmitted from a first transmit antenna during the first time interval 244.

An intermediate time period 246 directly succeeds (e.g., follows) the first time interval 244. The frequency of the radar signal is maintained at the second radio frequency over the entire intermediate time period 246. During the intermediate time period 246 the radar signal may be switched from the first transmit antenna to a second transmit antenna.

The intermediate time period 246 is directly succeeded (e.g., followed) by a second time interval 248. The frequency of the radar signal is linearly decreased over the radar bandwidth 242 during the second time interval 248. At the first instance of time of the second time interval 248, the frequency of the radar signal is equal to the second radio frequency and at the last instance of time of the second time interval 248 the frequency of the radar signal is equal to the first radio frequency. During the second time interval 248, the radar signal is transmitted from the second transmit antenna.

The first and the second time interval 244, 248 can, for example, be shorter than 500 μs, e.g., between 300 μs and 500 μs, between 150 μs and 300 μs, between 50 μs and 150 μs, or even shorter than 50 μs. The intermediate time period 246 is significantly shorter than the first time interval 244 and/or the second time interval 248, for example, between 1 μs and 2 μs, between 500 ns and 1 μs, or shorter than 500 ns.

The second time interval 248 is directly followed by a pause period 249. During the pause period, the transmission from the first and second transmit antenna may be paused, for example, by temporarily turning off power amplifiers coupled to the first and/or the second transmit antenna, which may reduce power consumption. Moreover, during the pause period, the frequency of the radar signal can be maintained at the first radio frequency and the radar signal can be switched back again to the first transmit antenna. The pause period 249 may be as short as the intermediate time period 246, or longer than the intermediate time period 246, for example, longer than twice as long, or longer than ten times as long as the intermediate time period 246.

After the pause period 249 has passed, the above described modulation and transmission from the first and second transmit antenna can be repeated. In this way, a series of linear frequency up-chirps can be transmitted from the first transmit antenna and a series of linear frequency down-chirps can be transmitted from the second transmit antenna. In this way, a position of a target can repeatedly be determined, which can improve the accuracy of the position determination (e.g., reduce noise) and/or the target can be tracked over time.

With the proposed modulation scheme of FIG. 2, a PLL providing the radar signal and controlling the frequency of the radar signal is, for example, not required to support large frequency jumps from a region with a low tuning sensitivity of a VCO comprised by the PLL to a region with a large tuning sensitivity of the VCO. A required maximum bandwidth (e.g. a maximum loop bandwidth of the PLL) is, for example, related to the number of points of a chirp (e.g., of a frequency up-chirp and/or of a frequency down-chirp). In this way, the system (e.g., the radar system) can be optimized for noise and linearity, for example. Moreover, in some examples, the frequency up-chirp during the first time interval may correspond to a saw tooth function, whereas the frequency down-chirp during the second time interval may correspond to a reverse saw tooth function. The intermediate time period 246 can optionally be used to switch a configuration between a first transmitter and a second transmitter. Furthermore, in some examples, the intermediate time period 246 can be as short as possible without any impact on the PLL bandwidth (e.g. the loop bandwidth of the PLL).

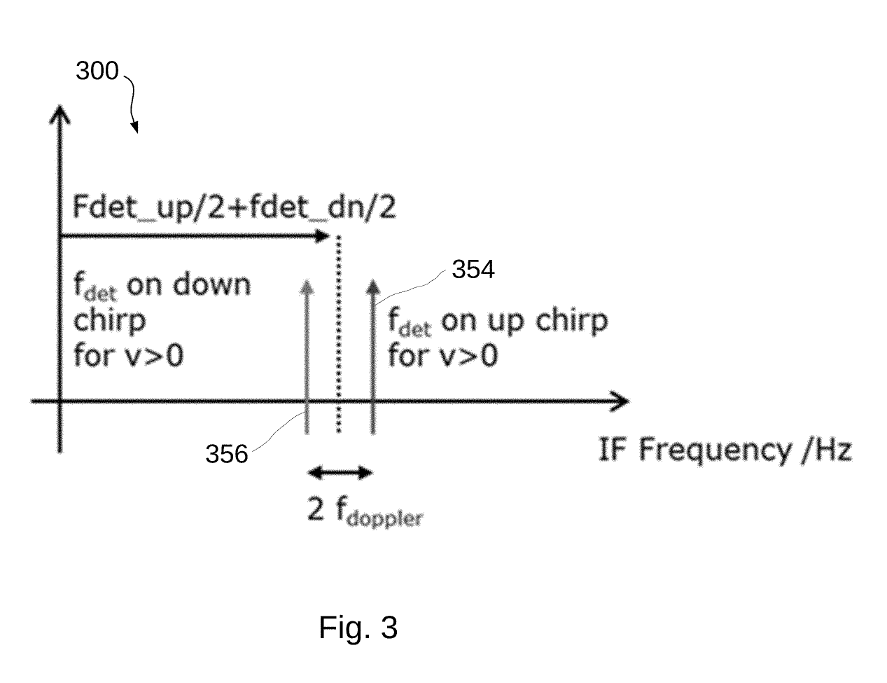

More details and aspects are mentioned in connection with the embodiments described above or below. The embodiment shown in FIG. 2 may comprise one or more optional additional features corresponding to one or more aspects mentioned in connection with the proposed concept or one or more embodiments described above (e.g. FIG. 1) or below (e.g. FIG. 3-7b).

FIG. 3 shows an example of a frequency domain representation 300 of received reflections of a radar signal according to an embodiment. The received reflections can, for example, be down-converted to an intermediate frequency at a receiver side of a radar system.

The received reflections can, for example, comprise a received first and second reflection. A received first reflection can correspond to a radar signal transmitted from a first transmit antenna during a first time interval, e.g., during a frequency up-chirp. As the first reflection can, for example, be received while the radar signal is transmitted during the first time interval, the instantaneous frequency of the first reflection may be compared to the instantaneous frequency of the radar signal transmitted from the first transmit antenna during the reception of the first reflection at the radar system. For example, the instantaneous frequency of the first reflection may be lower than the instantaneous frequency of the radar signal transmitted from the first transmit antenna due to a propagation time of the radar signal from the first transmit antenna to the target and back again to the radar system. The difference between the instantaneous frequency of the first reflection and the instantaneous frequency of the radar signal transmitted from the first transmit antenna can be indicative for a distance from the first transmit antenna to the target and/or for a speed of the target (e.g., a radial speed of the target relative to the first transmit antenna).

Analogously, a received second reflection can correspond to the radar signal transmitted from a second transmit antenna during a second time interval, e.g., during a frequency down-chirp. The second reflection may be received while the radar signal is transmitted during the second time interval. During the reception of the second reflection, the instantaneous frequency of the second reflection can be compared to the instantaneous frequency of the radar signal transmitted from the second transmit antenna. The instantaneous frequency of the second reflection may, for example, be higher than the instantaneous frequency of the radar signal transmitted from the second transmit antenna due to a propagation time of the radar signal from the second transmit antenna to the target and back again to the radar system. Again, the difference between the instantaneous frequency of the second reflection and the instantaneous frequency of the radar signal transmitted from the second transmit antenna can be indicative for a distance from the second transmit antenna to the target and/or for a speed of the target (e.g., a radial speed of the target relative to the second transmit antenna).

A detection frequency f_{det}, e.g., the frequency difference between the instantaneous frequency of the first/second reflection and the instantaneous frequency of the radar signal transmitted from the first/second transmit antenna, respectively, can be calculated as:

### Equation 1:

$${f}_{det} = 2 \frac{{f}_{0}}{{c}_{0}} {v}_{0} \pm 2 \frac{B}{T} \frac{{r}_{0}}{{c}_{0}}$$

The plus-sign is used in Equation 1 during the first time interval, e.g., during a linear frequency up-chirp, whereas the minus-sign is used in Equation 1 during the second time interval, e.g., during a linear frequency down-chirp. Without loss of generality, in Equation 1 it is assumed that the first and second time interval comprise an equal length T (e.g., equal up-chirp and down-chirp times). If the first and the second time interval were of different length, Equation 1 could be modified correspondingly by the skilled person. The variable B denotes the difference between the first radio frequency and the second radio frequency (e.g., the radar bandwidth), between which the frequency of the radar signal is linearly increased during the first time interval and linearly decreased during the second time interval. r₀ is the distance from the first and/or the second transmit antenna to the target, respectively. c₀ is the speed of light. f₀ is the arithmetic mean value of the first radio frequency and the second radio frequency, e.g., a RF center frequency. In other words, f₀ is the carrier frequency of the radar signal. v₀ is the radial speed of the target relative to the first and the second transmit antenna, respectively.

Hence, by inspection of Equation 1, the detection frequency f_{det} can arise from two components. A first component f_{doppler} of the detection frequency can be due to a radial speed v₀ of the target, which causes a Doppler frequency shift of the received first and second reflections:

### Equation 2:

$${f}_{doppler} = 2 \frac{{f}_{0}}{{c}_{0}} {v}_{0}$$

For a target moving towards the first and second transmit antenna (e.g., towards the radar system) the radial speed v₀ can comprises positive values. For a target moving away from the first and second transmit antenna (e.g., away from the radar system) the radial speed v₀ can comprises negative values.

A second component f_{dist} of the detection frequency can be due to a distance to the target, e.g., the distance from the first and second transmit antenna to the target:

### Equation 3:

$${f}_{dist} = \pm 2 \frac{B}{T} \frac{{r}_{0}}{{c}_{0}}$$

In Equation 3, the plus-sign is used during a frequency up-chirp and the minus-sign is used during a frequency down-chirp.

Referring to FIG. 3, a moving target can increase and/or decrease the detection frequency. Whether the detection frequency is increased or decreased, can depend on a chirp direction (e.g., whether the frequency of the radar signal is increased or decreased) and on a target movement direction. In FIG. 3, the target has a positive radial speed, such that during a frequency up-chirp (e.g., during the first time interval) the detection frequency is increased by a Doppler frequency shift f_{doppler}, resulting in a spectral component 354 of higher frequency. Analogously, during a frequency down-chirp (e.g., during the second time interval) the detection frequency is decreased by the same Doppler frequency shift, resulting in a spectral component 356 of lower frequency.

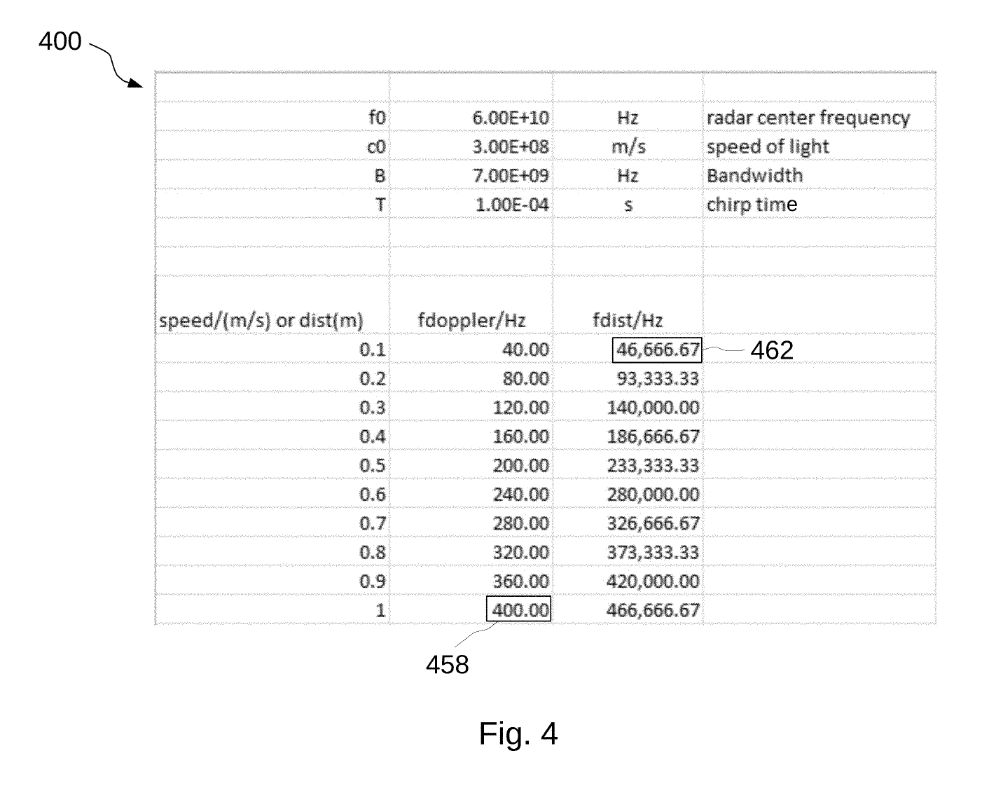

More details and aspects are mentioned in connection with the embodiments described above or below. The embodiment shown in FIG. 3 may comprise one or more optional additional features corresponding to one or more aspects mentioned in connection with the proposed concept or one or more embodiments described above (e.g. FIG. 1-2) or below (e.g. FIG. 4-7b).

FIG. 4 displays a table 400 comprising Doppler frequency shifts and frequency shifts due to a distance to a target for various distances and various speeds of the target for a set of modulation parameters. In this example, the modulation parameters comprise the RF center frequency f₀ (e.g. a radar center frequency) set to 60 GHz, the radar bandwidth B (e.g., the difference between the first and the second radio frequency) set to 7 GHz, and the lengths T of the first and second time interval (e.g., the chirp time), both set to 100 μs.

As already explained in connection with FIG. 1, according to embodiments of the present disclosure, modulation parameters of the radar signal can be optionally set to cause the Doppler frequency shift (e.g., f_{doppler}) in the received reflections to be significantly smaller than a frequency shift in the received reflections due to the distance to the target (e.g., f_{dist}). This can, for example, be accomplished by using a priori information about the target that is to be detected. For example, a radar system operating according to an embodiment can be designed for the detection of targets with a maximum radial speed and a minimum distance from the radar system. Such targets may, for example, comprise living beings or body parts of living beings.

A maximum radial speed (e.g., an assumed maximum radial speed) of the target can for example be lower than 10 m/s, lower than 5 m/s, or even lower than 1 m/s. The minimum distance to the target (e.g., an assumed minimum distance to the target) can, for example, be shorter than 10 m, shorter than 5 m, shorter than 1 m, or even as short or shorter than 10 cm.

In the example of the table 400 of FIG. 4 a maximum radial speed of the target is 1 m/s and the minimum distance to the target is 0.1 m. Correspondingly, the maximum Doppler frequency shift 458 amounts to 400 Hz, which is significantly lower (e.g., more than a hundred times lower) than a minimum frequency shift 462 of approximately 46.667 kHz due to a minimum distance to the target. That is to say, at least in some examples of ranging system that run fast chirps the Doppler shift may be very small compared to the frequency shift due to a distance to the target.

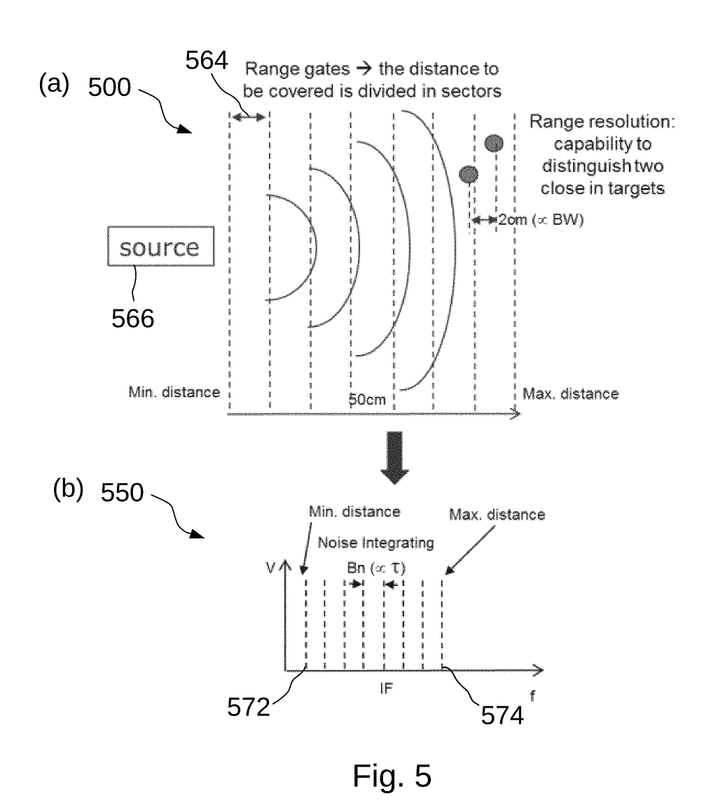

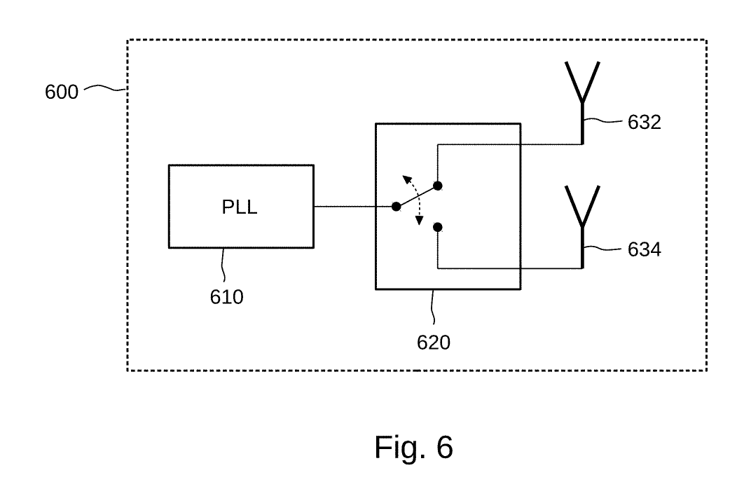

More details and aspects are mentioned in connection with the embodiments described above or below. The embodiment shown in FIG. 4 may comprise one or more optional additional features corresponding to one or more aspects mentioned in connection with the proposed concept or one or more embodiments described above (e.g. FIG. 1-3) or below (e.g. FIG. 5a-7b).

FIG. 5a shows a division of a range of a radar system 500 into range gates 564 according to an embodiment of the present disclosure. For example, the range of the radar system 500 can be divided into adjacent segments, which can, when stitched together, cover the entire range of the radar system 500. A range gate can, for example, be wider than 1 cm, e.g., between 1 cm and 10 cm, between 10 cm and 50 cm, between 50 cm and 100 cm, or even wider than 100 cm. A target detected in a range gate can cause a corresponding intermediate frequency at a receiver side of the radar system 500, as displayed by the frequency power spectrum 550 shown in FIG. 5b. A target in a range gate closest to a source 566 of the radar system 500 (e.g., the first and/or the second transmit antenna) can, for example, cause a minimum intermediate frequency 572 (e.g., a minimum detection frequency according to Equation 1). A target in a range gate furthest from the source 566 can, for example, cause a maximum intermediate frequency 574 (e.g., a maximum detection frequency according to Equation 1). A range resolution of the radar system can, for example, be defined as the capability of the radar system to distinguish two close targets.

FIG. 5a-b further show in connection with FIG. 4, that an intermediate frequency associated to a target at a specific distance can be several orders of magnitude larger than a Doppler frequency shift for at least some examples of ranging systems of the present disclosure, e.g., for ranging systems used for gesture sensing, wherein the range can be lower than, for instance, 10 m. Moreover, each range gate that can be associated to this system is in the range of 10 kHz (1/chirp trim).

In case the modulation parameters of the radar signal are set to cause a Doppler frequency shift in the received reflections to be significantly smaller than a frequency shift in the received reflections due to a distance to the target, as explained in connection with FIG. 4, an error (e.g., a positioning error) associated to a target due to the Doppler shift can be much smaller than the width of a range gate, for example, more than a hundred times, more than five-hundred times, or more than a thousand times smaller. In this way, the radar system 500 (e.g., a radar sensor) can still detect the target in the correct (e.g., expected) range gate. In this sense, the frequency up-chirp and the frequency down-chirp can be considered equivalent in the series of chirps performed in a frame. In turn, requirements on the PLL bandwidth and VCO can, for example, be relaxed. The bandwidth required (e.g., the loop bandwidth of the PLL) can be sufficient to provide the number of steps in a chirp with a specific linearity. The radar system can then, for example, be optimized for noise (e.g., phase noise) and linearity with a different trade-off.

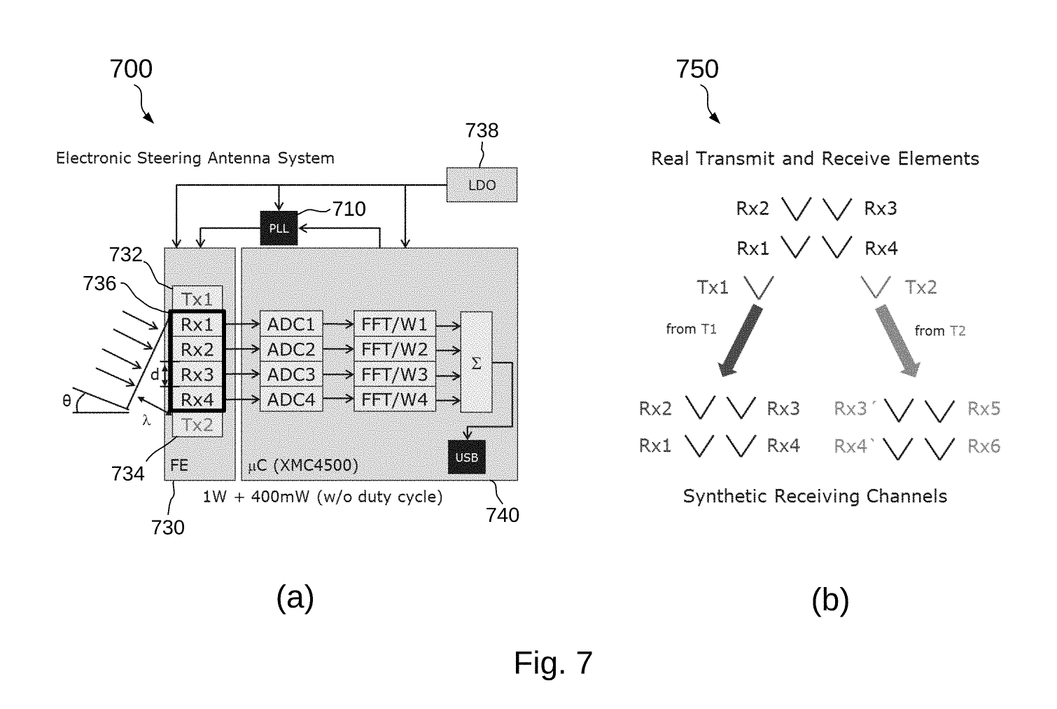

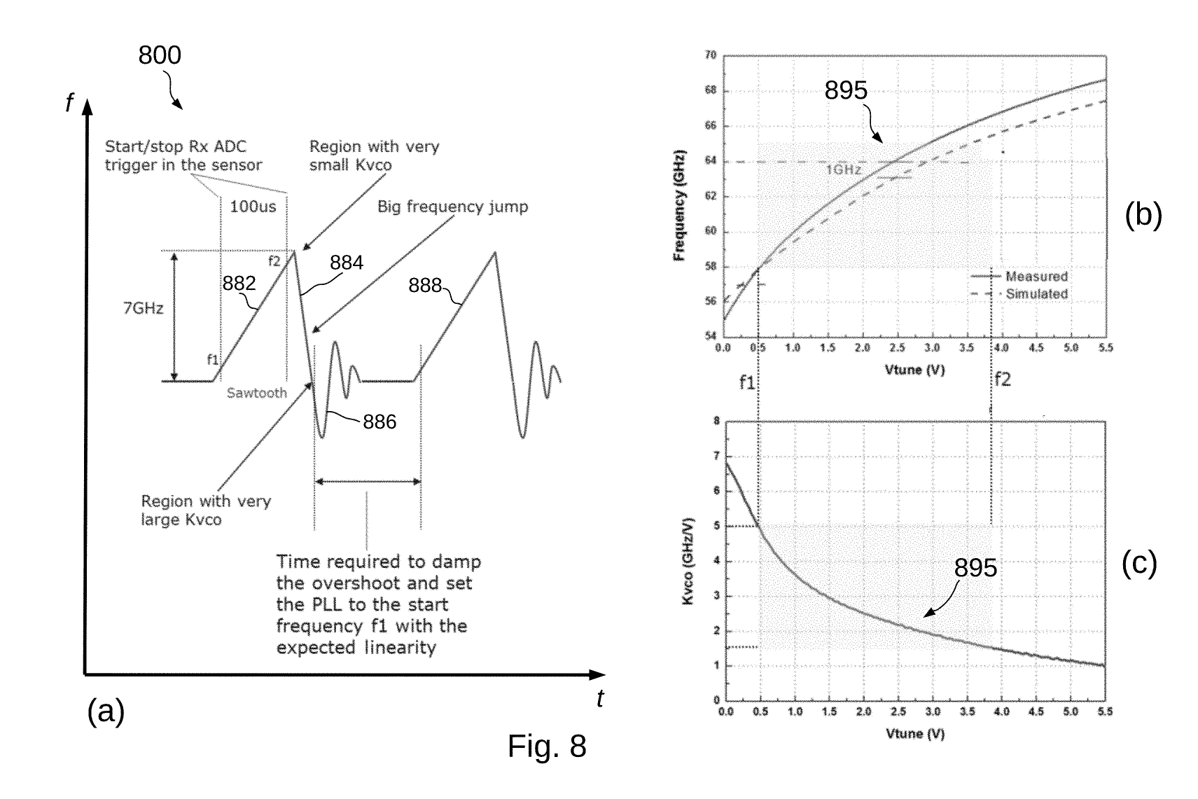

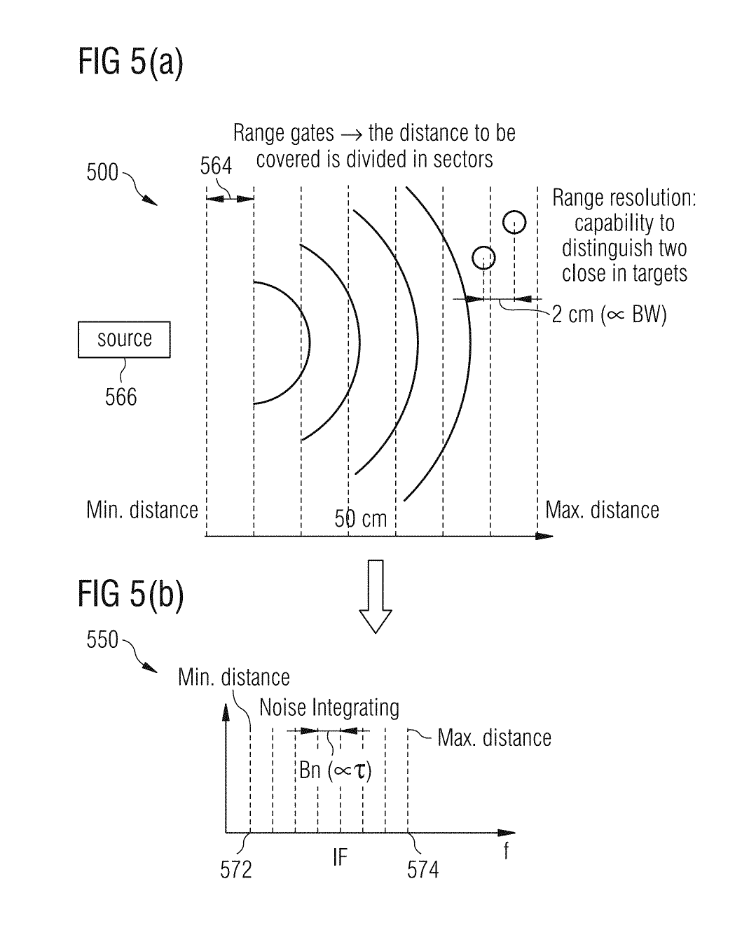

More details and aspects are mentioned in connection with the embodiments described above or below. The embodiment shown in FIG. 5a, b may comprise one or more optional additional features corresponding to one or more aspects mentioned in connection with the proposed concept or one or more embodiments described above (e.g. FIG. 1-4) or below (e.g. FIG. 6-7b).

FIG. 6 shows a block diagram of a radar system 600 according to an embodiment. The radar system 600 comprises a first transmit antenna 632 and at least one second transmit antenna 634. Additionally, the radar system 600 comprises a phase-locked loop 610 configured to increase the frequency of a radar signal during a first time interval and configured to decrease the frequency of the radar signal during a second time interval. The radar system 600 also comprises a signal switch 620 configured to switch (e.g., provide) the radar signal to the first transmit antenna 632 during the first time interval and to switch (e.g., provide) the radar signal to the second transmit antenna 634 during the second time interval.

The radar system 600 can, for example, be configured to perform the method described in connection with FIG. 1. Details concerning the implementation of the radar system 600 are mentioned above in connection with FIG. 1 to FIG. 5.

Optionally, a minimum distance between the first transmit antenna 632 and the at least one second transmit antenna 634 can be larger than a wavelength of the radar signal. The wavelength may for example correspond to a minimum free space wavelength of the radar signal. The free space wavelength of the radar signal can be minimal when the frequency of the radar signal is at a maximum, for example, after the frequency of the radar signal has been increased from a first radio frequency to a second radio frequency during the first time interval. At the second radio frequency, the free space wavelength of the radar signal can be minimal. The minimum free space wavelength can, for example, be shorter than 1 cm, e.g., between 1 cm and 5 mm, between 5 mm and 1 mm, or even shorter than 1 mm.

By a spatial separation of the first transmit antenna 632 and the second transmit antenna 634 of more than a wavelength of the radar signal (e.g. between one and two wavelengths, between two and five wavelengths, or even more than five wavelengths), the radar system 600 can, for example, operate according to a stereoscopic radar system, which can allow, for example, gaining information about the size and/or the shape of a target in addition to determining the position and/or the speed of the target. This can, for instance, be applied in gesture sensing radar systems, where different movements and/or different poses of body parts of living beings (e.g., of human beings and/or of animals) can be recognized, distinguished and/or interpreted by the radar system according to an embodiment.

Optionally, the radar system 600 can operate according to a frequency-modulated continuous-wave (FMCW) radar, e.g., a linearly frequency-modulated continuous-wave radar.

More details and aspects are mentioned in connection with the embodiments described above or below. The embodiment shown in FIG. 6 may comprise one or more optional additional features corresponding to one or more aspects mentioned in connection with the proposed concept or one or more embodiments described above (e.g. FIG. 1-5b) or below (e.g. FIG. 7a-b).

FIG. 7a shows another block diagram of a radar system 700 according to an example. The radar system 700 is similar to the radar system of FIG. 6. A PLL 710 is coupled to a radio frequency front-end 730. The radio frequency front-end 730 comprises a first transmit antenna 732 and a second transmit antenna 734 as well as a receive antenna array 736. The receive antenna array 736 comprises four receive antenna elements (e.g., for receive elements). Each receive antenna element is coupled to a dedicated receive channel. Each dedicated receive channel may provide a received intermediate frequency signal, as explained in connection with FIG. 5a, b. The intermediate frequency signals of the dedicated receive channels are each coupled to dedicated analog-to-digital converters (ADC), such that intermediate frequency signals can be processed and/or analyzed separately in a digital domain. For example, a Fast-Fourier-Transformation (FFT) of each intermediate frequency signal can be calculated. From the FFTs of the intermediate frequency signals a phase shift between the intermediate frequency signals can be calculated. The calculated phase shift can then be indicative for an angle Θ of incidence of the received reflections and hence indicative for a direction from the receive antenna array 736 to a target causing the reflections. In other words, the radar system 600 may determine a direction to a target based on digital beamforming on its receiver side.

Moreover, the FFTs of the intermediate frequency signals can be summed and their sum can be provided at a universal-serial-bus (USB) port. The analog-to-digital conversion of the intermediate frequency signals, the calculation of their FFTs, and the summation of the FFTs can, for example, be performed on a mixed-signal circuit 740, such as a micro-controller, a field-programmable gate array (FPGA), a digital signal processor (DSP), or an application specific integrated circuit (ASIC).

A voltage regulator 738 (e.g., a linear low dropout voltage regular and/or a switched voltage regulator) is used to supply power to the PLL 710, the RF front-end 730 and the mixed signal circuit 740.

Moreover, the PLL 710, the RF front-end 730, the mixed signal circuit 740 and the voltage regulator 738 can optionally be integrated into a common semiconductor package or into a common semiconductor die.

Furthermore, the radar system 700 shown in FIG. 7a can, for example, be based on a six channel transceiver for digital beam forming with two transmitters and four receivers. The radar system 700 may toggle from chirp to chirp (e.g., from a frequency up-chirp to a frequency down-chirp and vice versa) between Tx1, e.g., the first transmit antenna 732, and Tx2, e.g., the second transmit antenna 734.

FIG. 7b illustrates a concept 750, how a plurality of transmit elements may form a plurality of synthetic receiving channels out of real receive elements for the radar system 700. By a spatial separation of the first transmit antenna 732 from the second transmit antenna 734 of, for example, larger than a wavelength of the radar signal, the radar system 700 can operate according to a synthetic aperture radar. In turn, an angular resolution of the radar system 700 can be improved, for example two targets angularly separated by less than 10°, less than 5°, or even less than 2°, can be distinguished by the radar system 700.

More details and aspects are mentioned in connection with the embodiments described above or below. The embodiment shown in FIG. 7a, b may comprise one or more optional additional features corresponding to one or more aspects mentioned in connection with the proposed concept or one or more embodiments described above (e.g. FIG. 1-6) or below.

Some embodiments relate to a modulation scheme for gesture sensing systems and to ranging systems based on a transceiver consisting of two transmitters for digital beam forming. Such a system can perform a sequence of chirps in a frame while toggling between the two transmitters from chirp to chirp. Instead of running an up-chirp (e.g., a saw tooth) on both transmitters, in order to improve linearity of the chirps and simplify the PLL design, a first transmitter can use up-chirps and a second transmitter can use down-chirps. Those can be considered equivalent when very fast chirps are performed, e.g., the Doppler shift does not impact the intermediate frequency associated to a target.

Moreover, some embodiments relate to millimeter wave gesture sensing systems that require high resolution. High resolution can, for example, be achieved by using large bandwidth, for example, a bandwidth of 7 GHz or larger. Some millimeter wave gesture sensing systems may, for example, comprise VCOs with tuning voltages between 0 and 5 V, or less, corresponding to a frequency range of 7 GHz or larger. In portable, battery powered applications the tuning voltage range can be even smaller, for example between 0 and 3.7 V corresponding to a frequency range of, for example, 7 GHz or larger.

Example embodiments may further provide a computer program having a program code for performing one of the above methods, when the computer program is executed on a computer or processor. A person of skill in the art would readily recognize that acts of various above-described methods may be performed by programmed computers. Herein, some example embodiments are also intended to cover program storage devices, e.g., digital data storage media, which are machine or computer readable and encode machine-executable or computer-executable programs of instructions, wherein the instructions perform some or all of the acts of the above-described methods. The program storage devices may be, e.g., digital memories, magnetic storage media such as magnetic disks and magnetic tapes, hard drives, or optically readable digital data storage media. Further example embodiments are also intended to cover computers programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. It will thus be appreciated that those skilled in the art will be able to devise various arrangements that, although not explicitly described or shown herein, embody the principles of the disclosure and are included within its spirit and scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Furthermore, the following claims are hereby incorporated into the Detailed Description, where each claim may stand on its own as a separate embodiment. While each claim may stand on its own as a separate embodiment, it is to be noted that—although a dependent claim may refer in the claims to a specific combination with one or more other claims—other embodiments may also include a combination of the dependent claim with the subject matter of each other dependent or independent claim. Such combinations are proposed herein unless it is stated that a specific combination is not intended. Furthermore, it is intended to include also features of a claim to any other independent claim even if this claim is not directly made dependent to the independent claim.

It is further to be noted that methods disclosed in the specification or in the claims may be implemented by a device having means for performing each of the respective acts of these methods.

Further, it is to be understood that the disclosure of multiple acts or functions disclosed in the specification or claims may not be construed as to be within the specific order. Therefore, the disclosure of multiple acts or functions will not limit these to a particular order unless such acts or functions are not interchangeable for technical reasons. Furthermore, in some embodiments a single act may include or may be broken into multiple sub acts. Such sub acts may be included and part of the disclosure of this single act unless explicitly excluded.

What is claimed is:

1. A method for operating a radar system, the method comprising:
increasing a frequency of a radar signal during a first time interval;
transmitting the radar signal from a first transmit antenna during the first time interval;
decreasing the frequency of the radar signal during a second time interval; and
transmitting the radar signal from a second transmit antenna during the second time interval.

2. The method of claim 1, wherein increasing the frequency of the radar signal comprises increasing the frequency from a first radio frequency to a second radio frequency, and wherein decreasing the frequency of the radar signal comprises decreasing the frequency from the second radio frequency to the first radio frequency.

3. The method of claim 2, further comprising maintaining the frequency of the radar signal during an intermediate time period, wherein the intermediate time period directly succeeds the first time interval and directly precedes the second time interval.

4. The method of claim 3, wherein maintaining the frequency of the radar signal comprises maintaining the frequency at the second radio frequency.

5. The method of claim 3, further comprising switching the radar signal from the first transmit antenna to the second transmit antenna during the intermediate time period.

6. The method of claim 3, wherein at least one of the first time interval and the second time interval is at least thirty times longer than the intermediate time period.

7. The method of claim 1, wherein the first time interval is longer than half the second time interval and shorter than double the second time interval.

8. The method of claim 1, further comprising:
receiving a first reflection of the radar signal from a target during the first time interval;
receiving a second reflection of the radar signal from the target during the second time interval; and
determining a position of the target based on at least one of the received first reflection of the radar signal and the received second reflection of the radar signal.

9. The method of claim 8, further comprising setting a modulation parameter of the radar signal to cause a Doppler frequency shift in the received reflections to be smaller than fifty times a frequency shift in the received reflections due to a distance to the target.

10. The method of claim 9, wherein the modulation parameter of the radar signal comprises at least one of a carrier frequency, a first radio frequency, a second radio frequency, a difference between the first radio frequency and the second radio frequency, a length of the first time interval, and a length of the second time interval.

11. The method of claim 8, wherein receiving the first reflection of the radar signal and receiving the second reflection of the radar signal comprises digital beam-forming.

12. The method of claim 11, wherein determining a position of the target comprises determining a first position of the target based on at least the first received reflection of the radar signal, determining a second position of the target based on at least the second received reflection of the radar signal, and determining an averaged position of the target based on at least the first position and on the second position.

13. The method of claim 8, wherein the target is a living being or a body part of a living being.

14. A radar system comprising:
a first transmit antenna and at least one second transmit antenna;
a phase-locked loop configured to increase a frequency of a radar signal during a first time interval and configured to decrease the frequency of the radar signal during a second time interval; and
a signal switch configured to switch the radar signal to the first transmit antenna during the first time interval and to switch the radar signal to the second transmit antenna during the second time interval.

15. The radar system of claim 14, wherein a minimum distance between the first transmit antenna and the at least one second transmit antenna is larger than a wavelength of the radar signal.

16. The radar system of claim 14, wherein the radar system operates according to a frequency-modulated continuous-wave radar.

17. A radar system comprising:
a radio frequency (RF) front-end circuit comprising
a first output configured to be coupled to a first transmit antenna,
second output configured to be coupled to a second transmit antenna, and
a first input configured to receive a variable-frequency signal, wherein the RF front-end is configured to provide the variable-frequency signal to the first transmit antenna during a first time interval when the variable-frequency signal is increasing in frequency, and to provide the variable-frequency signal to the second transmit antenna during a second time interval when the variable frequency signal is decreasing in frequency.

18. The radar system of claim 17, further comprising a frequency generation circuit having an output coupled to the first input of the RF front-end circuit, the frequency generation circuit configured to produce the variable-frequency signal, wherein the frequency generation circuit is configured to increase the frequency of the variable-frequency signal during the first time interval and decrease the variable-frequency signal during the second time interval.

19. The radar system of claim 18, wherein the frequency generation circuit comprises a phase-locked loop.

20. The radar system of claim 17, wherein the RF front-end circuit comprises a first transmitter coupled to the first output and a second transmitter coupled to the second output.
